(19) United States
(12) Patent Application Publication
(10) Pub. No.: US 2008/0301096 A1
(43) Pub. Date: Dec. 4, 2008

(54) Techniques to manage metadata fields for a taxonomy system

(75) Inventors: Daniel E. Kogan, Issaquah, WA (US); Patrick C. Miller, Sammamish, WA (US); Gerhard A. Schobbe, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/807,392

(22) Filed: May 29, 2007

(51) Int. Cl. G06F 17/30

(52) U.S. Cl. 707/3; 707/E17.005

(57) ABSTRACT

Techniques to manage metadata fields for a taxonomy system are described. An apparatus may comprise a processor and memory, the memory to store a vocabulary management module and a smart field management module for execution by the processor. The vocabulary management module may be arranged to manage a taxonomy of managed vocabulary terms organized in a hierarchical structure. The smart field management module may be arranged to receive a candidate vocabulary term for a smart metadata field, compare the candidate vocabulary term with the managed vocabulary terms, and validate the candidate vocabulary term for storage by the smart metadata field. Other embodiments are described and claimed.

### BACKGROUND

A managed taxonomy system attempts to manage a taxonomy for an application, device or network. A taxonomy attempts to define a common or standard vocabulary for interacting with an application or system. The standard vocabulary may then be used for different applications, such as classification applications, search applications, tagging applications, and so forth. To create a standard vocabulary, managed taxonomy systems attempt to build and manage a highly structured and formalized hierarchy of standard vocabulary terms. Managed taxonomy systems, however, are typically difficult to maintain and manage. For example, introduction of new vocabulary terms may potentially conflict with managed vocabulary terms. Furthermore, new vocabulary terms may provide little if any contextual or semantic knowledge that may be used by the managed taxonomy system. Consequently, there may be a need for improved techniques for managing vocabulary terms for a managed taxonomy system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to techniques for managing vocabulary terms for a managed taxonomy system. Some embodiments may be particularly directed to techniques related to implementing and managing smart metadata fields for a resource to provide tighter integration with managed taxonomy systems. Smart metadata fields may comprise specifically defined data structures that initiate certain vocabulary management operations using data stored or suggested for storage by the data structure. Rather than simply storing information applied to any free-form metadata field, information such as vocabulary terms entered into a smart metadata field may be systematically refined to improve use or placement in a managed taxonomy system. In this manner, the smart metadata fields and associated methods may increase the contextual and semantic value of the vocabulary terms for a managed taxonomy system, which may in turn utilize the vocabulary terms to provide improved metadata services to a device, system or user.

In various embodiments, an apparatus may comprise a processor and memory. The memory may store various software components for execution by the processor, such as a vocabulary management module and a smart field management module. The vocabulary management module may be arranged to manage a taxonomy of managed vocabulary terms organized in a hierarchical structure. The smart field management module may be arranged to receive a candidate vocabulary term for a smart metadata field, compare the candidate vocabulary term with the managed vocabulary terms maintained by the vocabulary management module, and validate the candidate vocabulary term for use or storage by the smart metadata field. For example, the smart field management module may accept or deny the candidate vocabulary term for storage by the smart metadata field. The smart field management module may also provide or suggest alternate locations appropriate for the candidate vocabulary terms, such as various alternate metadata fields associated with the same resource as the smart metadata field, for example.

In various embodiments, the memory may also store other software components in support of smart metadata field operations, such as a vocabulary disambiguation module and vocabulary parsing module. The vocabulary disambiguation module may be arranged to perform vocabulary disambiguation operations to provide alternate vocabulary terms for the vocabulary management module, including managed vocabulary terms. The vocabulary parsing module may be arranged to perform vocabulary parsing operations to provide candidate vocabulary terms suitable for use as metadata information for a resource. In this manner, the vocabulary parsing module may be used to process a resource and provide a list of candidate vocabulary terms for storage by a smart metadata field or metadata field associated with the resource. Other embodiments are described and claimed.

### BRIEF DESCRIPTION OF THE DRAWINGS

FIG. 1 illustrates one embodiment of managed taxonomy system.

FIG. 2 illustrates one embodiment of a logic flow.

FIG. 3 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” or similar language are not necessarily referring to the same embodiment.

Various embodiments may be generally directed to techniques to manage vocabulary terms for a managed taxonomy system. A taxonomy may generally refer to a structure, method or technique for classifying information or data. A taxonomy is generally composed of taxonomic units singularly known as taxon and collectively known as taxa. In various embodiments, the taxon may comprise one or more vocabulary terms, while the taxa may include the entire set of vocabulary terms defined for a given system. A managed taxonomy may refer to a taxonomy that is managed in accordance with a formal set of rules, procedures or guidelines for a given system. A managed taxonomy system may be any system arranged to store, process, communicate, and otherwise manage a defined taxonomy for an electronic system or collection of electronic systems.

Vocabulary terms for a managed taxonomy typically include multiple managed vocabulary terms. Managed vocabulary terms may generally refer to any vocabulary terms that are under the supervision, control and management of a managed taxonomy system. Examples of managed vocabulary terms may include formal vocabulary terms and informal vocabulary terms.

Formal vocabulary terms may generally refer to vocabulary terms that have been through a formal review process for full acceptance into the taxonomy hierarchy. The managed taxonomy system may review vocabulary terms for acceptance into the managed taxonomy. Part of the formal review process may include identifying whether the vocabulary term has a logical position in the hierarchical organization of the taxonomy. For example, if the taxonomy is organized as a tree hierarchy, the managed taxonomy system may arrange the managed vocabulary terms as nodes with links to parent and/or child nodes. The managed taxonomy system may employ certain semantic and syntax rules to determine the appropriate position for the candidate vocabulary term in this rigid hierarchical structure. The managed taxonomy system may also define certain characteristics or features for managed vocabulary terms, such as a syntax rules, associations with certain resources or data objects, equality relationships or synonyms with other managed vocabulary terms, ontological relationships with other managed vocabulary terms, context, and so forth. The number and type of formal review and acceptance procedures for a managed taxonomy system are virtually limitless and may vary by implementation.

Informal vocabulary terms may generally refer to a new vocabulary term introduced into a managed taxonomy system without formal acceptance in the taxonomy hierarchy. In some cases, the managed taxonomy system may provide the informal vocabulary term some basic structure. The basic structure is typically less than the formal structure given to formal vocabulary terms. For example, the basic structure may be a specifically defined category for informal vocabulary terms. In some embodiments, the specifically defined category may be referred to as a “hybrid” category. The managed taxonomy system may use the hybrid category to perform basic taxonomy management operations for the informal vocabulary terms, while reducing or avoiding the need to process the informal vocabulary terms in accordance with the formal review procedures implemented for the managed taxonomy system.

In general application, managed vocabulary terms are typically associated with a given resource. A resource may represent a single discrete object or set of data. The resource may comprise hardware elements, software elements, or a combination of both. For example, a resource could be a software element such as document, spreadsheet, picture or other electronic file. In another example, a resource could be a hardware element such as a component, device or system. These are merely some examples of a resource, and the embodiments are not intended to be limited in this context.

In some cases, there may be other types of information associated with a resource that are not easily accessible or available to a managed taxonomy system. For example, a resource may have one or more basic data structures associated with the resource designed to hold undefined information or values. This may be contrasted with a data structure designed to hold specifically defined values, such as presented by a pick list for a column or field and selected by a user for placement in the data structure. Such undefined information is of little or no value to a managed taxonomy system since there are no contextual relationships with defined information, such as managed vocabulary terms in a managed taxonomy. One example of a basic data structure of this type may include a keyword field associated with a resource such as a document. A user may enter undefined information in the keyword field, including any number of user-defined vocabulary terms. The user-defined vocabulary terms may include managed vocabulary terms or unmanaged vocabulary terms, but in any event are typically not used by a managed taxonomy information since the basic data structure is designed to hold information that is assumed to be undefined information.

As a result, the information and vocabulary terms stored by a basic data structure provide little if any contextual or semantic value to the managed taxonomy system. Rather, the information remains opaque to the managed taxonomy system and therefore is typically not available for providing any metadata services beyond simple keyword searches. In some cases, the information stored by a basic data structure may actually be in conflict with vocabulary terms managed by the managed taxonomy system, thereby introducing potential ambiguity from a user perspective. In other cases, the information stored by the basic data structure may actually be more appropriate for other fields associated with a resource. Consequently, potential opportunities for defining and using user-defined metadata information may be reduced or lost, which may otherwise have been used to provide greater contextual and semantic information to support metadata services and managed taxonomy systems.

Various embodiments attempt to solve these and other potential problems. Some embodiments may introduce concepts and techniques for implementing and managing smart metadata fields in a managed taxonomy system. The smart metadata fields may be used to receive and potentially store user-defined or suggested vocabulary terms in a more formal and useful manner. Once a user proposes a candidate vocabulary term for a resource, and attempts to enter the candidate vocabulary term into a smart metadata field, various vocabulary management operations may be initiated to assist the user in defining more consistent and effective metadata information for the resource that is suitable for use by a managed taxonomy system. The vocabulary management operations may include, for example, performing vocabulary validating operations to validate a candidate vocabulary term for storage by a smart metadata field, performing vocabulary disambiguation operations to provide some clarity for vocabulary terms with multiple definitions, performing vocabulary location operations to search and provide alternate fields or data structures that may be suitable for storing a candidate vocabulary term, performing vocabulary parsing operations to parse a resource for candidate vocabulary terms suitable for use as metadata information representing the resource and storage by a smart metadata field or other resource-related field, and so forth.

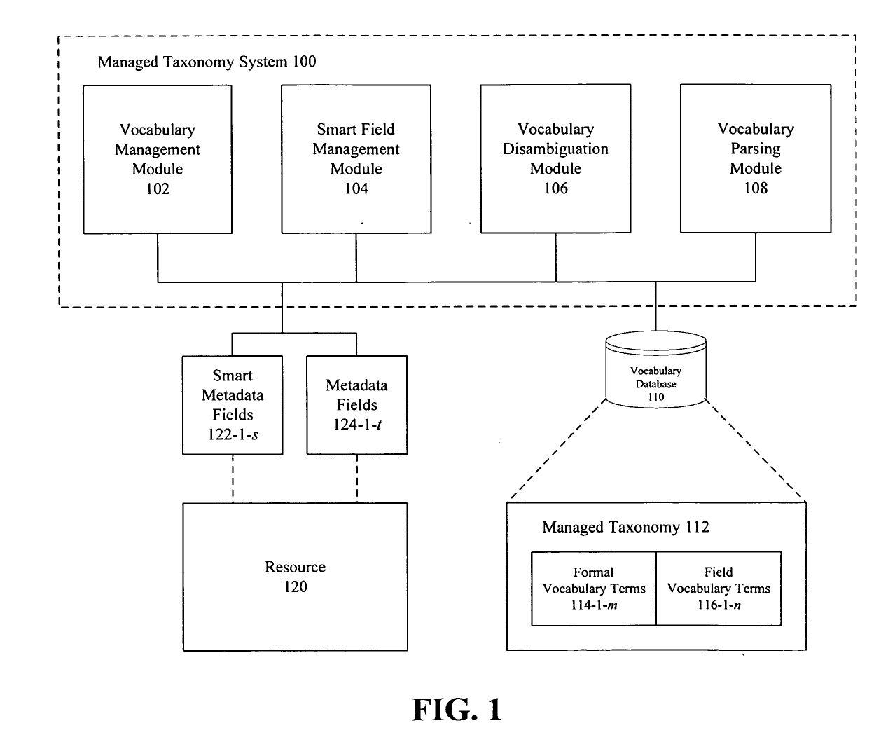

FIG. 1 illustrates a block diagram of a managed taxonomy system 100. The managed taxonomy system 100 may represent any system arranged to store, process, communicate, and otherwise manage a defined or managed taxonomy for an electronic system or collection of electronic systems. As shown in FIG. 1, one embodiment of the managed taxonomy system 100 may include a vocabulary management module 102, a smart field management module 104, a vocabulary disambiguation module 106, a vocabulary parsing module 108, and a vocabulary database 110.

As used herein the term “module” may include any structure implemented using hardware elements, software elements, or a combination of hardware and software elements. In one embodiment, for example, the modules described herein are typically implemented as software elements stored in memory and executed by a processor to perform certain defined operations. Although some embodiments show a limited number of modules, it may be appreciated that some or all of the defined operations may be implemented using more or less modules as desired for a given implementation. Furthermore, although some embodiments are described using software elements stored by memory for execution by a processor, it may be appreciated that some or all of the defined operations may be implemented using hardware elements based on various design and performance constraints. The embodiments are not limited in this context.

In various embodiments, the managed taxonomy system 100 may be used to manage any defined taxonomy. An entity such as a company, business or enterprise may use different application programs to manage information across the entity. Often the vocabulary and taxonomy for an entity varies with the type of entity and a given set of products and/or services. In one embodiment, for example, the managed taxonomy system 100 may be used to manage specific vocabulary terms for entities operating within a computing and/or communications environment, sometimes referred to as an online environment. In this context such vocabulary terms are sometimes referred to as “metadata.” Metadata may refer to structured, encoded data that describe characteristics of information-bearing entities to aid in the identification, discovery, assessment, and management of the described entities. Generally, a set of metadata describes a single object or set of data, called a resource. Metadata may be of particular use for such applications as information retrieval, information cataloging, and the semantic web. For example, the vocabulary terms may be metadata used as tags for tagging operations. A tag is a relevant keyword or term associated with or assigned to a piece of information or resource. The tag may thus describe the resource and enable keyword-based classification of the resource.

Referring again to FIG. 1, the managed taxonomy system 100 may be used to define information or metadata for a resource, such as resource 120. The resource 120 may comprise any type of discrete objects formed using software elements, hardware elements, or a combination of both, as previously described. Information or metadata for the resource 120 may be entered or stored using a smart metadata field, such as one or more smart metadata fields 120-1-s. A smart metadata field may comprise any defined data structure having associated vocabulary management operations, methods or techniques implemented by the smart field management module 104 that are initiated when a user attempts to define or enter vocabulary terms into a smart metadata field. Examples of suitable data structures may include without limitation a field, metadata field, column, array, type, class, definition and so forth.

In one embodiment, for example, the managed taxonomy system 100 may include the vocabulary management module 102. The vocabulary management module 102 may be arranged to manage vocabulary terms for a managed taxonomy 112 stored by vocabulary database 110. The managed taxonomy 112 may comprise various types, such as managed vocabulary terms 114-1-m and informal vocabulary terms 116-1-n, where m and n represent positive integers. In one embodiment, for example, the vocabulary management module 102 may organize the managed taxonomy 112 with the managed vocabulary terms 114-1-m in a hierarchical structure. The vocabulary management module 102 may also create and maintain a hybrid category for informal vocabulary terms 116-1-n stored as a list of keywords.

In one embodiment, for example, the managed taxonomy system 100 may include the smart field management module 104. The smart field management module 104 may be arranged to receive and process candidate vocabulary terms for a smart metadata field, such as one or more smart metadata fields 122-1-s for the associated resource 120. The smart field management module 104 may compare a candidate vocabulary term with the managed vocabulary terms of the managed taxonomy 112, and validate the candidate vocabulary term for storage by the smart metadata field 122-1-s. For example, the smart field management module 104 may accept the candidate vocabulary term for storage by the smart metadata field 122-1-s, or deny the candidate vocabulary term for storage by the smart metadata field 122-1-s, based on a set of smart field processing rules. The smart field processing rules may be a set of rules defined to guide a user in the types of vocabulary terms that should be used for a given smart metadata field 122-1-s. For example, if the designer or implementer of the managed vocabulary system 100 desired to constrain users to entering only managed vocabulary terms into a smart metadata field 122-1-s, rules may be added to the smart field processing rules set to accept managed vocabulary terms for storage by the smart metadata field 122-1-s, and deny all other vocabulary terms for storage by the smart metadata field 122-1-s. In another example, if the designer or implementer of the managed vocabulary system 100 desired to constrain users to entering only formal vocabulary terms into a smart metadata field 122-1-s, rules may be added to the smart field processing rules set to accept formal vocabulary terms for storage by the smart metadata field 122-1-s, and deny all other vocabulary terms (e.g., information vocabulary terms) for storage by the smart metadata field 122-1-s. In yet another example, a smart field processing rule may be implemented to accept any type of vocabulary term regardless of its relationship to the managed taxonomy 112. Any number and type of smart field processing rules may be implemented to guide user behavior in a manner desired for a given implementation.

In one embodiment, for example, the smart field management module 104 may be arranged to provide alternate metadata fields associated with the resource to store the candidate vocabulary term. As part of the validation operations, or separate from the validation operations, the smart field management module 104 may locate and suggest alternate metadata fields suitable for storing the candidate vocabulary term. In addition to a smart metadata field 122-1-s, the resource 120 may have additional metadata fields (or columns) associated with the resource 120, such as one or more metadata fields 124-1-t. Some of the additional metadata fields 124-1-t may be arranged to store certain managed vocabulary terms from the managed taxonomy 112. In this case, the smart field management module 104 may search the managed taxonomy 112 stored by the vocabulary database 110 for managed vocabulary terms (e.g., formal vocabulary terms 114-1-m, informal vocabulary terms 116-1-n) that are similar to, or exactly matching, a candidate vocabulary term for the smart metadata field 122-1-s. When there is a match, the smart field management module 104 may retrieve any metadata fields 124-1-t designed to store the matching managed vocabulary term, and present a list of such metadata fields 124-1-t to the user. The user may decide whether the candidate vocabulary term should be used for any of the suggested metadata fields 124-1-t, and provide user selections for the desired metadata fields 124-1-t. The smart field management module 104 may receive the user selection, and promote the candidate vocabulary term (or matching managed vocabulary term) to the selected metadata fields 124-1-t. In this manner, the user is given the opportunity to define metadata information for the resource 120 within the confines of the managed taxonomy 112 as managed by the managed taxonomy system 100.

In one embodiment, for example, the managed taxonomy system 100 may include the vocabulary disambiguation module 106. The vocabulary disambiguation module 106 may be arranged to provide alternate vocabulary terms for the candidate vocabulary term. For example, a user may enter a candidate vocabulary term having multiple meanings or definitions. In this case, the vocabulary disambiguation module 106 may provide, suggest or display multiple definitions for the candidate vocabulary term to allow the user an opportunity to select the appropriate definition. Once a definition is selected, the vocabulary disambiguation module 106 may provide, suggest or display any synonyms for the candidate vocabulary term. This may allow the user an opportunity to refine word choices to more precisely reflect the intended meaning. In another example, a user may enter a partial spelling for a candidate vocabulary term, or a misspelled version for a candidate vocabulary term. In this case, the vocabulary disambiguation module 106 may provide, suggest or display alternate versions of the vocabulary term to allow the user an opportunity to select the appropriate spelling. In this manner, the vocabulary disambiguation module 106 allows a user opportunities to select a candidate vocabulary term that precisely reflects the intended meaning of the user.

In one embodiment, for example, the vocabulary disambiguation module 106 may provide, suggest or display alternate vocabulary terms comprising managed vocabulary terms from the managed taxonomy 112. For example, a user may enter a candidate vocabulary term for a smart metadata field 122-1-s. The vocabulary disambiguation module 106 may perform various vocabulary disambiguation operations as previously described to ensure the candidate vocabulary term precisely reflects the meaning intended by the user. Once the user selects an appropriate version of the candidate vocabulary term, the vocabulary disambiguation module 106 may perform a search of the managed taxonomy 112 stored by the vocabulary database 110 for managed vocabulary terms (e.g., formal vocabulary terms 114-1-m, informal vocabulary terms 116-1-n) that are similar to, or exactly matching, the candidate vocabulary term for the smart metadata field 122-1-s. When there is a match, the vocabulary disambiguation module 104 may provide, suggest or display a list of managed vocabulary terms resulting from the database search. The user may decide whether to substitute the candidate vocabulary term with a managed vocabulary term from the search list. The vocabulary disambiguation module 106 may receive the user selection, convert or replace the original candidate vocabulary term with the selected managed vocabulary term, and store the selected managed vocabulary term in the smart metadata field 122-1-s. In this manner, the user is given the opportunity to define metadata information for the resource 120 using terminology consistent with the managed taxonomy 112 of the managed taxonomy system 100.

In one embodiment, for example, the managed taxonomy system 100 may include the vocabulary parsing module 108. The vocabulary parsing module 108 may be arranged to parse a resource for the candidate vocabulary term suitable for use as metadata information representing the resource and storage by the smart metadata field. In this case, a user would not directly enter a candidate vocabulary term into a smart metadata field 122-1-s. Rather, the vocabulary parsing module 108 would parse the content of the resource 120, and suggest relevant terms and phrases suitable for metadata information representative of the resource 120. The vocabulary parsing module 108 would provide, suggest or display a list of the parsed terms or phrases as potential candidate vocabulary terms for a smart metadata field 122-1-s. The user may select a term from the list, and the managed taxonomy system 100 may perform certain vocabulary management operations for the candidate vocabulary term as previously described (e.g., validation, disambiguation, and so forth). Alternatively, the vocabulary parsing module 108 may perform certain vocabulary management operations for the parsed terms or phrases prior to presentation to the user. For example, the vocabulary parsing module 108 may output the parsed terms and phrases to the vocabulary disambiguation module 106 to perform matching operations with managed vocabulary terms, and presenting only those parsed terms and phrases matching a corresponding managed vocabulary term, thereby reducing or obviating the need to for a user to initiate some vocabulary management operations for the smart metadata fields 122-1-s.

In one embodiment, for example, the managed taxonomy system 100 may include the vocabulary database 110. Vocabulary database 110 may be used to store the managed taxonomy 112 for the managed taxonomy system 100. In one embodiment, for example, the managed taxonomy 112 may be implemented as a hierarchical structure of various types, commonly displaying parent-child relationships. Although one embodiment may describe a managed taxonomy 112 in terms of a hierarchical structure or organization, the managed taxonomy 112 may also be implemented as other non-hierarchical structures having various topologies, such as network structures, organization of objects into groups or classes, alphabetical lists, keyword lists, and so forth. The embodiments are not limited in this context.

Operations for the managed taxonomy system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the managed taxonomy system 100 or alternative elements as desired for a given set of design and performance constraints.

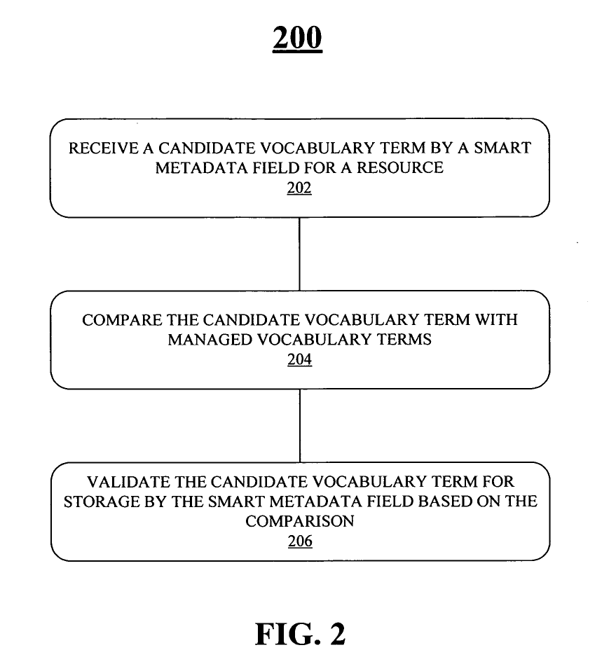

FIG. 2 illustrates a logic flow 200. Logic flow 200 may be representative of the operations executed by one or more embodiments described herein. As shown in logic flow 200, the logic flow 200 may receive a candidate vocabulary term by a smart metadata field for a resource at block 202. The logic flow 200 may compare the candidate vocabulary term with managed vocabulary terms at block 204. The logic flow 200 may validate the candidate vocabulary term for storage by the smart metadata field based on the comparison at block 206. The embodiments are not limited in this context.

In one embodiment, the logic flow 200 may receive a candidate vocabulary term by a smart metadata field for a resource at block 202. For example, a user may select a smart metadata field 122-1-s, and begin entering the candidate vocabulary term directly into the selected smart metadata field 122-1-s. Alternatively, a user may select a smart metadata field 122-1-s, and initiate a dialog wizard or other graphic user interface (GUI) to manage entry and selection of the candidate vocabulary term.

In one embodiment, the logic flow 200 may compare the candidate vocabulary term with managed vocabulary terms at block 204. For example, the vocabulary disambiguation module 106 may search the managed taxonomy 112 stored by the vocabulary database 110 for managed vocabulary terms (e.g., formal vocabulary terms 114-1-m, informal vocabulary terms 116-1-n) that are similar to, or exactly matching, the candidate vocabulary term for the smart metadata field 122-1-s. In cases where there is not an exact match between a candidate vocabulary term and a managed vocabulary term, a set of heuristics or rules may be used to retrieve managed vocabulary terms most similar to the candidate vocabulary term.

In one embodiment, the logic flow 200 may validate the candidate vocabulary term for storage by the smart metadata field based on the comparison at block 206. For example, the smart field management module 104 may accept the candidate vocabulary term for storage by the smart metadata field 122-1-s, or deny the candidate vocabulary term for storage by the smart metadata field 122-1-s, based on a set of smart field processing rules. The smart field management module 104 may also provide conditional validation based on modifications to the candidate vocabulary term suggested by the smart field management module 104 or some other element of the managed taxonomy system 112.

In one embodiment, one or more alternate vocabulary terms may be provided or suggested for the candidate vocabulary term. For example, the vocabulary disambiguation module 106 may be arranged to provide alternate vocabulary terms for a given candidate vocabulary term to reduce or obviate ambiguity for the candidate vocabulary term. This may be useful when a candidate vocabulary term has multiple definitions, spellings, synonyms, and so forth.

In one embodiment, one or more alternate managed vocabulary terms from a managed taxonomy may be provided or suggested for the candidate vocabulary term. For example, the vocabulary disambiguation module 106 may provide, suggest or display alternate vocabulary terms comprising managed vocabulary terms from the managed taxonomy 112. The user may decide whether to substitute the candidate vocabulary term with a managed vocabulary term from the search list. The vocabulary disambiguation module 106 may receive the user selection, convert or replace the original candidate vocabulary term with the selected managed vocabulary term, and store the selected managed vocabulary term in the smart metadata field 122-1-s. In this manner, the user is given the opportunity to define metadata information for the resource 120 using terminology potentially more consistent with the managed taxonomy 112 of the managed taxonomy system 100.

In one embodiment, one or more alternate metadata fields associated with a resource may be provided or suggested for storing the candidate vocabulary term. For example, the smart field management module 104 may be arranged to provide alternate metadata fields associated with the resource to store the candidate vocabulary term. When the candidate vocabulary term matches a managed vocabulary term of the managed taxonomy 112, the smart field management module 104 may retrieve any metadata fields 124-1-t designed to store the matching managed vocabulary term, and present a list of such metadata fields 124-1-t to the user. The smart field management module 104 may receive a user selection, and promote the candidate vocabulary term (or matching managed vocabulary term) to the selected metadata fields 124-1-t. In this manner, the user is given the opportunity to define metadata information for the resource 120 within the confines of the managed taxonomy 112 as managed by the managed taxonomy system 100, thereby allowing the managed taxonomy system 100 to more effectively use the information stored by the smart metadata field 122-1-s.

In one embodiment, a resource may be parsed for candidate vocabulary terms suitable for use as metadata information representing the resource and storage by a smart metadata field. For example, the vocabulary parsing module 108 may be arranged to parse a resource for the candidate vocabulary term suitable for use as metadata information representing the resource and storage by the smart metadata field. The vocabulary parsing module 108 parses content for the resource 120, and suggests relevant terms and phrases suitable for metadata information representative of the resource 120. The vocabulary parsing module 108 would provide, suggest or display a list of the parsed terms or phrases as potential candidate vocabulary terms for a smart metadata field 122-1-s.

The various vocabulary management operations of the managed taxonomy system 100 may be further illustrated by way of example. Assume a user enters the term “longhorn” into a smart metadata field 122-1-s for a resource, such as a keyword field of a document. The vocabulary disambiguation module 106 may prompt the user to disambiguate between “longhorn” the code name for MICROSOFT® WINDOWS®, and “longhorn” a type of highland cattle. If the user selects the MICROSOFT WINDOWS product, the system could then suggest the preferred synonym “WINDOWS VISTA™.” If the user accepts the suggestion they could be prompted with the recommendation of applying the term “WINDOWS VISTA” to the “Related Technologies” metadata field in the document's metadata schema because that field is bound to a managed vocabulary in which the term “WINDOWS VISTA” is found. Consequently, the use of the smart metadata fields 122-1-s by the managed taxonomy system 100 may provide, facilitate or support capabilities to have type-a-head, validation, suggestion and promotion between fields and suggestions of alternatives for users to provide more well-defined and meaningful metadata information for the resource 120.

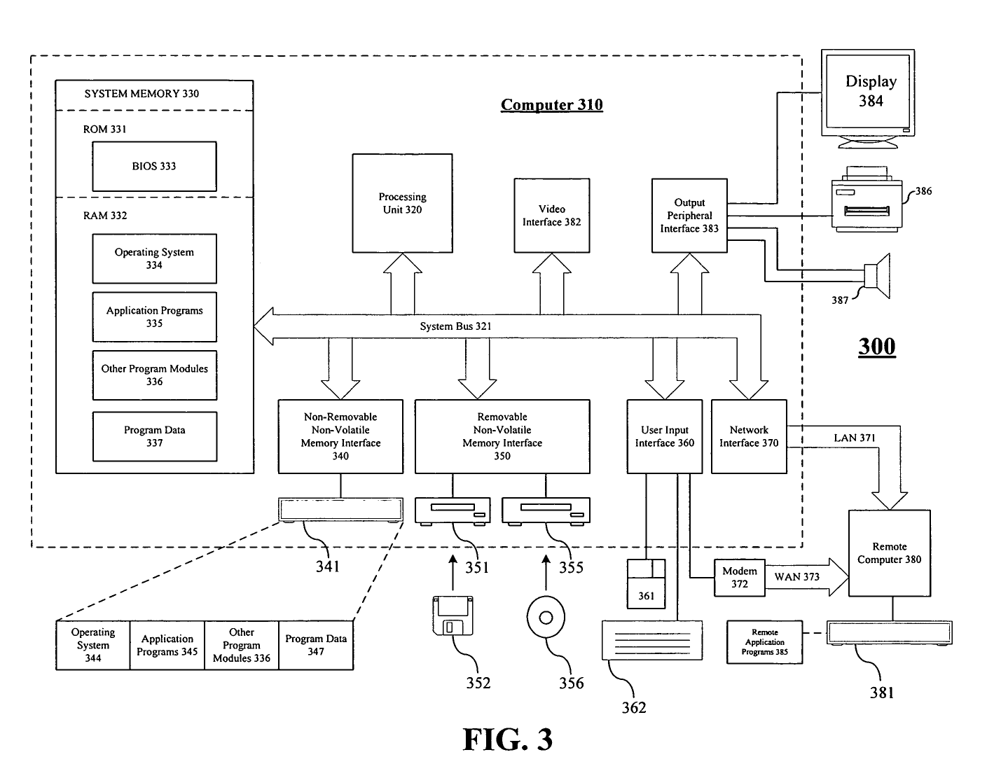

FIG. 3 illustrates a block diagram of a computing system architecture 300 suitable for implementing various embodiments, including the managed taxonomy system 100. It may be appreciated that the computing system architecture 300 is only one example of a suitable computing environment and is not intended to suggest any limitation as to the scope of use or functionality of the embodiments. Neither should the computing system architecture 300 be interpreted as having any dependency or requirement relating to any one or combination of components illustrated in the exemplary computing system architecture 300.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 3, the computing system architecture 300 includes a general purpose computing device such as a computer 310. The computer 310 may include various components typically found in a computer or processing system. Some illustrative components of computer 310 may include, but are not limited to, a processing unit 320 and a memory unit 330.

In one embodiment, for example, the computer 310 may include one or more processing units 320. A processing unit 320 may comprise any hardware element or software element arranged to process information or data. Some examples of the processing unit 320 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 320 may be implemented as a general purpose processor. Alternatively, the processing unit 320 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 310 may include one or more memory units 330 coupled to the processing unit 320. A memory unit 330 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 310. The embodiments are not limited in this context.

In one embodiment, for example, the computer 310 may include a system bus 321 that couples various system components including the memory unit 330 to the processing unit 320. A system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 310 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 300. Examples of computer readable media for computing system architecture 300 may include, but are not limited to, volatile and/or nonvolatile memory such as ROM 331 and RAM 332. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 330 includes computer storage media in the form of volatile and/or nonvolatile memory such as ROM 331 and RAM 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 384 or other type of display device is also connected to the system bus 321 via an interface, such as a video interface 382. In addition to the monitor 384, computers may also include other peripheral output devices such as speakers 387 and printer 386, which may be connected through an output peripheral interface 383.

The computer 310 may operate in a networked environment using logical connections to one or more remote computers, such as a remote computer 380. The remote computer 380 may be a personal computer (PC), a server, a router, a network PC, a peer device or other common network node, and typically includes many or all of the elements described above relative to the computer 310, although only a memory storage device 381 has been illustrated in FIG. 3 for clarity. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other technique suitable for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other techniques for establishing a communications link between the computers may be used. Further, the network connections may be implemented as wired or wireless connections. In the latter case, the computing system architecture 300 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the managed taxonomy system 100 and/or computing system architecture 300 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,”, “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a candidate vocabulary term by a smart metadata field for a resource;
comparing the candidate vocabulary term with managed vocabulary terms; and
validating the candidate vocabulary term for storage by the smart metadata field based on the comparison.

2. The method of claim 1, comprising accepting the candidate vocabulary term for storage by the smart metadata field.

3. The method of claim 1, comprising denying the candidate vocabulary term for storage by the smart metadata field.

4. The method of claim 1, comprising providing alternate vocabulary terms for the candidate vocabulary term.

5. The method of claim 1, comprising providing alternate managed vocabulary terms from a managed taxonomy for the candidate vocabulary term.

6. The method of claim 1, comprising replacing the candidate vocabulary term with a managed vocabulary term.

7. The method of claim 1, comprising providing alternate metadata fields associated with the resource to store the candidate vocabulary term.

8. The method of claim 1, comprising parsing the resource for the candidate vocabulary term suitable for use as metadata information representing the resource and storage by the smart metadata field.

9. An article comprising a storage medium containing instructions that if executed enable a system to:
receive a candidate vocabulary term by a smart metadata field;
compare the candidate vocabulary term with managed vocabulary terms from a managed taxonomy; and
validate the candidate vocabulary term for storage by the smart metadata field based on the comparison.

10. The article of claim 9, further comprising instructions that if executed enable the system to accept the candidate vocabulary term for storage by the smart metadata field.

11. The article of claim 9, further comprising instructions that if executed enable the system to deny the candidate vocabulary term for storage by the smart metadata field.

12. The article of claim 9, further comprising instructions that if executed enable the system to provide alternate vocabulary terms for the candidate vocabulary term.

13. The article of claim 9, further comprising instructions that if executed enable the system to provide alternate managed vocabulary terms from a managed taxonomy for the candidate vocabulary term.

14. The article of claim 9, further comprising instructions that if executed enable the system to provide alternate metadata fields associated with the resource to store the candidate vocabulary term.

15. The article of claim 9, further comprising instructions that if executed enable the system to parse a resource for the candidate vocabulary term suitable for use as metadata information representing the resource and storage by the smart metadata field.

16. An apparatus comprising a processor and memory, the memory to store a vocabulary management module and a smart field management module for execution by the processor, the vocabulary management module arranged to manage a taxonomy of managed vocabulary terms organized in a hierarchical structure, the smart field management module to receive a candidate vocabulary term for a smart metadata field, compare the candidate vocabulary term with the managed vocabulary terms, and validate the candidate vocabulary term for storage by the smart metadata field.

17. The apparatus of claim 16, the smart field management module to accept the candidate vocabulary term for storage by the smart metadata field, or deny the candidate vocabulary term for storage by the smart metadata field, based on a set of smart field processing rules.

18. The apparatus of claim 16, the smart field management module to provide alternate metadata fields associated with the resource to store the candidate vocabulary term.

19. The apparatus of claim 16, the memory storing a vocabulary disambiguation module for execution by the processor, the vocabulary disambiguation module arranged to provide alternate vocabulary terms for the candidate vocabulary term, the alternate vocabulary terms comprising managed vocabulary terms from the taxonomy.

20. The apparatus of claim 16, the memory storing a vocabulary parsing module for execution by the processor, the vocabulary parsing module arranged to parse a resource for the candidate vocabulary term suitable for use as metadata information representing the resource and storage by the smart metadata field.
